(19) United States
(12) Patent Application Publication
(10) Pub. No.: US 2010/0141806 A1
(43) Pub. Date: Jun. 10, 2010

(54) Moving Object Noise Elimination Processing Device and Moving Object Noise Elimination Processing Program

(75) Inventors: Tomomasa Uemura, Osaka (JP); Manabu Iguchi, Hokkaido (JP)

Correspondence Address: MILLS & ONELLO LLP, ELEVEN BEACON STREET, SUITE 605, BOSTON, MA, 02108, US

(73) Assignees: KANSAI UNIVERSITY, Osaka (JP); National University Corporation Hokkaido University, Hokkaido (JP)

(21) Appl. No.: 12/531,184

(22) PCT Filed: Mar. 10, 2008
(86) PCT No.: PCT/JP2008/054271

§ 371 Date: Jan. 21, 2010

(30) Foreign Application Priority Data
Mar. 15, 2007 (JP) 2007-066558

(51) Int. Cl. H04N 5/217

(52) U.S. Cl. 348/241; 348/E05.024

(57) ABSTRACT

A moving object noise elimination processing device and a moving object noise elimination processing program are provided for making it possible to effectively eliminate a noise due to a moving object in front of a photographing object with a relatively simple method. A moving object noise elimination process involves first photographing an image every predetermined sampling interval Δt and the photographed images are stored in association with time (S10, S12). Next, with respect to the currently photographed image frame data and the previously photographed image frame data, each corresponding pixel brightness value is compared (S14, S16, S18). For each pixel, the one with a higher brightness value is then eliminated as a noise and that with lower brightness value is left (S20). The brightness value in each pixel of the image frame is updated with the left brightness value in each pixel and the updated one is output (S22, S24). Further, a moving object frequency is calculated from a ratio of the total number of data to the number of data with the eliminated brightness values and the calculated one is output (S26, S28).

### TECHNICAL FIELD

The present invention relates to a moving object noise elimination processing device and a moving object noise elimination processing program and, more particularly, to a moving object noise elimination processing device and a moving object noise elimination processing program eliminating a moving object in front that is noise for an object to be imaged from a shot image frame if a moving object exists in front.

### BACKGROUND ART

An image frame shot by an imaging camera includes various noises along with data related to an object to be imaged. Therefore, image processing for processing an image frame is executed to extract only necessary data related to the object to be imaged or to eliminate unnecessary noises. Especially when a moving object is shot, the moving object is an object to be imaged in some cases and the moving object is a noise in other cases. Although the moving object may be extracted with a movement detecting means in the former cases, the moving object is a noise and the data of the moving object is eliminated in the latter cases. When the moving object exists behind the object to be imaged, the moving object is not considered as a noise since the object to be imaged is not disturbed by the moving object. Therefore, the moving object is considered as a noise when the moving object exists in front of the object to be imaged. In such a case, the noise due to the moving object must be eliminated to extract the background behind the moving object as the object to be imaged.

For example, Patent Document 1 discloses an image processing device and a distance measuring device storing n images acquired in time series and accumulating and averaging these images to obtain an average background. It is stated in this document that, for example, if a movement speed of a moving object is high and the moving object exists in only one image of n images, the moving object appearing in only one image contributes to less density and becomes equal to or less than a threshold value in the average of the n images and disappears from the accumulated image.

Patent Document 2 discloses an image processing method of detecting edges having predetermined or greater intensity in image data and obtaining a movement direction, a movement amount, etc., of a moving object based on this detection to extract a background when blurs are formed in a panning shot. An edge profile is created from the detected edges to obtain a blurring direction, i.e., a movement direction of a moving object from the histogram of the blurs of the edges for eight directions and to obtain a movement amount of the moving object from a blurring width, i.e., an edge width in the blurring direction. It is stated that edges having edge widths equal to or greater than a predetermined threshold value are detected to define an area not including the edges as a background area.

Nonpatent Literature 1 discloses a snowfall noise eliminating method using a time median filter. The time median filter is a filter that arranges pixel values in descending order of luminance values for pixels of a plurality of frames of a video acquired from a fixed monitoring camera to define a k-th luminance value as the output luminance at the current time. This is executed for all the pixels to create an image with the output luminance at the current time and it is stated that a filter capable of eliminating snow from the image at the current time is formed by setting k=3, for example, if snow is shot in only two frames.

Patent document 1: Japanese Patent Application Laid-Open Publication No. 6-337938

Patent document 2: Japanese Patent Application Laid-Open Publication No. 2006-50070

Nonpatent literature 1: Miyake, et al., “Snowfall Noise Elimination Using a Time Median Filter,” IIEEJ Transactions, Vol. 30, No. 3, pp. 251-259 (2001)

### DISCLOSURE OF THE INVENTION

### Problems to Be Solved by the Invention

An example of the case of requiring a moving object to be eliminated as a noise occurs if an outdoor situation is shot by a monitoring camera when it is raining or snowing. For example, when it is snowing heavily, even if a person exists or a vehicle travels, the person or the vehicle is hidden by snow, which is a moving object in front, and cannot be sufficiently monitored from a shot image frame. If illumination is increased to enhance the monitoring, falling snow is more intensely imaged and the person, vehicle, etc., of interest are more frequently hidden.

A similar example occurs for a vehicle traveling at night. Although a vehicle traveling at night may detect an obstacle in front with an infrared camera, an ultrasonic camera, etc., in some cases, when it is raining or snowing, the rain or snow is detected by infrared or ultrasonic imaging and a pedestrian or an obstacle cannot be sufficiently detected from a shot image frame if existing in front. Even if the output power of infrared or ultrasonic waves is increased, falling snow, etc., are merely intensely imaged.

Since accumulating and averaging of images are performed in the method of Patent Document 1, a memory capacity is increased and a long time is required for the processing. Since the histogram processing of edge blurring for eight directions is required in the method of Patent Document 2, a memory capacity is increased and a long time is required for the processing. Although the snowfall noise elimination is performed in Nonpatent literature 1, the medians of luminance values of pixels are obtained from data of a plurality of video frames and complex calculations are required.

As above, according to the conventional technologies, advanced image processing is required for eliminating noises of moving objects and a large memory capacity and a long time are required for the processing.

It is the object of the present invention to provide a moving object noise elimination processing device and a moving object noise elimination processing program capable of effectively eliminating a moving object noise with a relatively simple method.

### Means to Solve the Problems

A moving object noise elimination processing device of the present invention comprises a fixed imaging device that shoots an object to be imaged with a moving object in front thereof as an image frame; a memory that stores a shot image frame in correlation with time series of the shooting; and a processing means that processes the shot image frame, the processing means including a means that reads an image frame shot at a time before the current time from the memory, a means that compares luminance values of corresponding pixels of both image frames between pixels making up the read image frame and pixels making up an image frame shot at the current time, a noise eliminating means that eliminates a higher luminance value as a noise and leaves a lower luminance value for each of pixels to update the luminance values of the pixels, and a means that outputs the image frame with luminance values updated for the pixels based on a predetermined update criterion as an image frame of the object to be imaged.

A moving object noise elimination processing device of the present invention comprises a fixed imaging device that shoots an object to be imaged with a moving object in front thereof as an image frame; a memory that stores a plurality of the shot image frames in correlation with time series of the shooting; and a processing means that processes the shot image frames, the processing means including a means that reads a plurality of image frames from the memory, a means that generates a luminance value frequency distribution for each of pixels making up the image frames based on luminance values of the pixels in a plurality of the read image frames, a noise eliminating means that leaves a luminance value of the highest frequency in the luminance value frequency distribution for each of the pixels and eliminates other luminance values as noises, and a means that outputs an image made up of the pixels with the luminance values of the highest frequency as an image frame of the object to be imaged.

A moving object noise elimination processing device of the present invention comprises two fixed imaging devices that shoot an object to be imaged with a moving object in front thereof as image frames, the two fixed imaging devices being arranged with a separation distance from each other such that the positions of the object to be imaged in the respective shot image frames are mismatched within arbitrarily predefined pixels in the image frames; a memory that stores the two respective image frames shot by the fixed imaging devices; and a processing means that processes the shot image frames, the processing means including a means that reads two image frames from the memory, a means that compares luminance values of corresponding pixels of the two image frames between pixels making up the two image frames, a noise eliminating means that eliminates a higher luminance value as a noise and leaves a lower luminance value for each of pixels and updates the luminance values of the pixels, and a means that outputs the image frame with luminance values updated for the pixels based on a predetermined update criterion as an image frame of the object to be imaged.

The moving object noise elimination processing device of the present invention preferably comprises a means that estimates a frequency of presence of the moving object in front of the object to be imaged based on the total number of data of luminance values of pixels making up an image frame and the number of data of luminance values eliminated as noises and outputs the frequency of presence as a moving object frequency.

In the moving object noise elimination processing device of the present invention, the moving object may be falling snow.

The moving object noise elimination processing device of the present invention may comprise a lighting device that applies light from the fixed imaging device side toward the object to be imaged.

A moving object noise elimination processing program of the present invention is a program of executing a moving object noise elimination process by shooting an object to be imaged with a moving object in front thereof as an image frame with a fixed imaging device and by processing the shot image frame on a computer, the program operable to drive the computer to execute a processing step of reading an image frame shot at a time before the current time from a memory that stores an image frame shot by the fixed imaging device in correlation with time series of the shooting; a processing step of comparing luminance values of corresponding pixels of both image frames between pixels making up the read image frame and pixels making up an image frame shot at the current time; a noise elimination processing step of eliminating a higher luminance value as a noise and leaving a lower luminance value for each of pixels and updating the luminance values of the pixels; and a processing step of outputting the image frame with luminance values updated for the pixels based on a predetermined update criterion as an image frame of the object to be imaged.

A moving object noise elimination processing program of the present invention is a program of executing a moving object noise elimination process by shooting an object to be imaged with a moving object in front thereof as an image frame with a fixed imaging device and by processing the shot image frame on a computer, the program operable to drive the computer to execute a processing step of reading a plurality of image frames from a memory that stores image frames shot by the fixed imaging device in correlation with time series of the shooting; a processing step of generating a luminance value frequency distribution for each of pixels making up the image frames based on luminance values of the pixels in a plurality of the read image frames; a noise elimination processing step of leaving a luminance value of the highest frequency in the luminance value frequency distribution for each of the pixels and eliminating other luminance values as noises; and a processing step of outputting an image made up of the pixels with the luminance values of the highest frequency as an image frame of the object to be imaged.

A moving object noise elimination processing program of the present invention is a program of executing a moving object noise elimination process by shooting image frames with two fixed imaging devices that shoot an object to be imaged with a moving object in front thereof as image frames, and that are arranged with a separation distance from each other such that the positions of the object to be imaged in the respective shot image frames are mismatched within arbitrarily predefined pixels in the image frames and by processing the shot image frames on a computer, the program operable to drive the computer to execute a processing step of reading two image frames from a memory that stores the two respective image frames shot by the fixed imaging devices; a processing step of comparing luminance values of corresponding pixels of the two image frames between pixels making up the two image frames; a noise elimination processing step of eliminating a higher luminance value as a noise and leaving a lower luminance value for each of pixels and updating the luminance values of the pixels; and a processing step of outputting the image frame with luminance values updated for the pixels based on a predetermined update criterion as an image frame of the object to be imaged.

### EFFECTS OF THE INVENTION

At least one of the above configurations uses a fixed imaging device, a memory, and a processing means that processes a shot image frame for moving object noise elimination processing. The processing means is a computer. Luminance values of corresponding pixels are compared between an image frame shot at a time before the current time and an image frame shot at the current time to eliminate pixels having higher luminance values as noises. Since an object closer to the imaging device is generally imaged brighter, a moving object on the front side has a higher luminance value than an object to be imaged on the back side. Therefore, the above configurations enable the moving object noise to be eliminated from two images, and if an image frame shot at the current time is acquired, the moving object noise may be eliminated substantially in real time by the simple luminance value comparison with an image frame already shot before that time. Therefore, the moving object noise may effectively be eliminated with a relatively simple method.

At least one of the above configurations uses a fixed imaging device, a memory, and a processing means that processes a shot image frame for moving object noise elimination processing. The processing means is a computer. The frequency distribution of luminance values of corresponding pixels is generated in a plurality of image frames at different shot times to leave the data of the highest frequency for each of the pixels and to eliminate other data as a noise. Since the moving object moves over time, the moving object does not stop at each pixel and the luminance value of the moving object varies at each pixel depending on time. On the other hand, when the object to be imaged behind the moving object is located at a fixed position or is in a substantially stationary state, each pixel has a substantially fixed luminance value. Therefore, when the object to be imaged is located at a fixed position or is in a substantially stationary state, the moving object noise may be eliminated from a plurality of images. For example, if the generation of the frequency distribution of luminance values is sequentially updated each time an image is shot, the moving object noise may be eliminated substantially in real time in accordance with the acquisition of the currently shot image frame. Therefore, the moving object noise may be effectively eliminated with a relatively simple method.

At least one of the above configurations uses two fixed imaging devices, a memory, and a processing means that processes a shot image frame for moving object noise elimination processing. The processing means is a computer. The two fixed imaging devices are arranged with a separation distance from each other such that the positions of the object to be imaged in the respective shot image frames are mismatched within arbitrarily defined pixels in the image frames. The luminance values of corresponding pixels are compared between two image frames shot at the same time by the two fixed imaging devices to eliminate pixels having higher luminance values as noises. When the two fixed imaging devices are arranged as above, even if the object to be imaged moves, the positions of the object to be imaged are matched within a range of predetermined arbitrary pixels in the two image frames shot by the two fixed imaging devices. On the other hand, in the case of a moving object closer than the object to be imaged, the positions of the moving object are not matched in the two image frames shot by the two fixed imaging devices. Since an object closer to the imaging device is generally imaged brighter, the moving object on the front side has a higher luminance value than the object to be imaged on the back side. Therefore, the above configurations enable the moving object noise to be eliminated from two images, and if two image frames are acquired from the two fixed imaging devices, the moving object noise may be eliminated substantially in real time by the simple luminance value comparison between the two image frames. Therefore, the moving object noise may be effectively eliminated with a relatively simple method.

The above configurations estimate the frequency of presence of the moving object in front of the object to be imaged based on the comparison between a total number of data of luminance values of pixels making up image frames and a number of data of luminance values eliminated as noises to output the moving object frequency. Therefore, the information related to the frequency of presence of the moving object in front of the object to be imaged may be acquired in addition to the noise elimination. For example, if the moving object is falling snow, information may be acquired for an amount of snowfall, etc., per unit time. Alternatively, if the moving object is a vehicle traveling on a road, information may be acquired for the number of passing vehicles, etc., per unit time.

A lighting device may be provided to apply light from the fixed imaging device side toward the object to be imaged. Although the noise is only increased due to the moving object in front of the object to be imaged even if the lighting device is provided in the conventional technologies, the noise due to the moving object may be eliminated regardless of the presence of the lighting.

### BRIEF DESCRIPTION OF DRAWINGS

FIG. 1 is a diagram explaining a configuration of a moving object noise elimination processing device in an embodiment according to the present invention.

FIG. 2 is a flowchart of procedures of the moving object noise elimination in the embodiment according to the present invention.

FIG. 3 is a diagram of an example of an image frame shot at a certain time in the embodiment according to the present invention.

FIG. 4 is a diagram of an image frame shot at a time different from FIG. 3 in the embodiment according to the present invention.

FIG. 5 is a diagram of how a noise due to snowfall is eliminated based on the data of FIGS. 3 and 4 in the embodiment according to the present invention.

FIG. 6 is a diagram of an example of calculation and temporal transition of a moving object frequency in the embodiment according to the present invention.

FIG. 7 is a flowchart of procedures of eliminating the moving object noise based on frequency distribution of luminance values of pixels in another example.

FIG. 8 is a diagram of how the luminance value distribution is obtained for each of corresponding pixels in another example.

FIG. 9 is a diagram explaining a principle of eliminating noise due to a moving object in front of an object to be imaged with the use of two cameras when the object to be imaged moves in another example.

FIG. 10 is a flowchart of procedures of eliminating the moving object noise with the use of two cameras in another example.

### EXPLANATIONS OF LETTERS OR NUMERALS

4 moving object; 6 object to be imaged; 8 outdoor situation; 10 moving object noise elimination processing device; 12, 50, 52 camera; 14 lighting device; 20 computer; input unit; 26 output unit; 28 imaging device interface; storage device; 32 storage/readout module; 34 luminance value processing module; 36 noise elimination module; 38 image output module; 40 moving object frequency output module; 42, 60, 62 image frame; and 44 luminance value frequency distribution.

### BEST MODES FOR CARRYING OUT THE INVENTION

Embodiments according to the present invention will now be described in detail with reference to the accompanying drawings. Although the description will hereinafter be made of the case of eliminating a moving object, which is falling snow, as a noise under the outdoor snowy condition using lighting in a system monitoring an outdoor situation having an object to be eliminated as a noise due to a moving object, this is an example for description. The monitoring may be performed within a structure such as a building rather than outdoors. The moving object may be other than falling snow, and may be the falling rain, for example. Alternatively, the moving object may be an object passing in front of a monitored object such as pedestrians or passing vehicles.

A fixed imaging device means a device fixed relative to an observer and down not mean a device fixed to the ground. Therefore, an imaging device mounted on a vehicle with an observer onboard corresponds to the fixed imaging device. For example, the present invention is applicable when an imaging device fixed to a vehicle is used to image and monitor a situation of obstacles in front of the vehicle with the use of headlights while the vehicle is moving. The observer may not be an actual person. In this case, an imaging device fixed to a monitoring device corresponds to the fixed imaging device.

Although moving object frequency output will be described with falling snow as the moving object, the moving object may be the falling rain, pedestrians, and travelling vehicles and, in such cases, the moving object frequency is information related to a rainfall amount per unit time, information related to the number of passing pedestrians per unit time, information related to the number of passing vehicles per unit time, etc. The same applies to moving objects other than those mentioned above.

### First Example

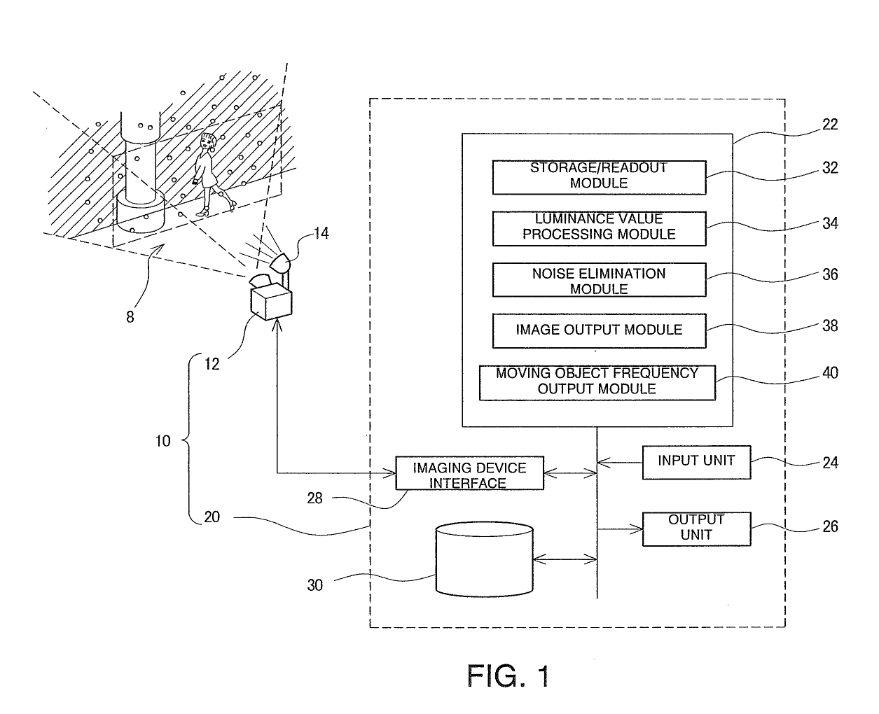

FIG. 1 is a diagram explaining a configuration of a moving object noise elimination processing device 10. The moving object noise elimination processing device 10 shown is mounted on a system monitoring outdoor situations. The outdoor situation monitoring system is made up of a camera 12 that is a fixed imaging device and a computer 20 that processes data shot by the camera 12 to output the data as monitored image frames. The moving object noise elimination processing device 10 is a portion of the outdoor situation monitoring system, is made up of the camera 12 and the computer 20 as hardware like the outdoor situation monitoring system, and is implemented as software by executing a moving object elimination processing program included in the monitoring program executed by the computer 20. FIG. 1 depicts a configuration of the moving object noise elimination processing device 10 in an extracted manner within the outdoor situation monitoring system.

FIG. 1 also depicts an outdoor situation 8 to be monitored, which is not a constituent element of the moving object noise elimination processing device 10. The outdoor situation 8 is depicted as a situation of a snowy outdoor area including a person. The situation to be monitored is an outdoor scene normally including no person, and when a suspicious person, etc., appears in this scene, the person, etc., are imaged and reported to a monitoring agency, etc. A portion of the person may disappear due to falling snow even if the person appears and is imaged, since falling snow exists in front of the person, and the incomplete person data is generated in the shot image frame. FIG. 1 depicts a case where falling snow generates a noise as the moving object in front of the object to be imaged.

The camera 12 is an imaging device set at a fixed position in the outdoor situation monitoring system as above and has a function of imaging the outdoor situation at predetermined sampling intervals to output the imaging data of each sampling time as electronic data of one image frame under the control of the computer 20. The output electronic data is transferred to the computer through a signal line. The camera 12 may be provided with a lighting device 14 capable of applying appropriate light to the outdoor situation 8 depending on the environment, such as nighttime. The camera 12 may be a CCD (Charged Coupled Device) digital electronic camera, etc.

The computer 20 has a function of processing data of the image frame shot and transferred from the camera 12 to eliminate the moving object noise such as falling snow in the outdoor situation 8 in this case.

The computer 20 is made up of a CPU 22, an input unit 24 such as a keyboard, an output unit 26 such as a display or a printer, an imaging device I/F 28 that is an interface circuit for the camera 12, and a storage device 30 that stores programs as well as image frame data, etc., transferred from the camera 12. These elements are mutually connected through an internal bus. The computer 20 may be made up of a dedicated computer suitable for image processing and may be made up of a PC (Personal Computer) in some cases.

The CPU 22 includes a storage/readout module 32, a luminance value processing module 34, a noise elimination module 36, an image output module 38, and a moving object frequency output module 40. These functions are related to data processing of an image frame. Therefore, the CPU 22 has a function as a means of processing a shot image frame. The storage/readout module 32 has a function of storing the image frame data transferred from the camera 12 in the storage device 30 in correlation with each sampling time and a function of reading the image frame data from the storage device 30 as needed. The luminance value processing module 34 has a function of comparing luminous values of corresponding pixels. The noise elimination module 36 has a function of leaving one luminance value of the compared luminance values and eliminating other luminance values as a noise in accordance with a predetermined criterion. The image output module 38 has a function of synthesizing and outputting the image frame of the object to be imaged based on the luminance values left for the pixels, and the moving object frequency output module 40 has a function of estimating the frequency of presence of the moving object based on the rate of the number of data of the eliminated luminance values and the number of data of the left luminance values, and outputting the frequency as the moving object frequency. These functions may be implemented by software and are specifically implemented by executing the moving object elimination processing program included in the monitoring program executed by the computer 20 as above.

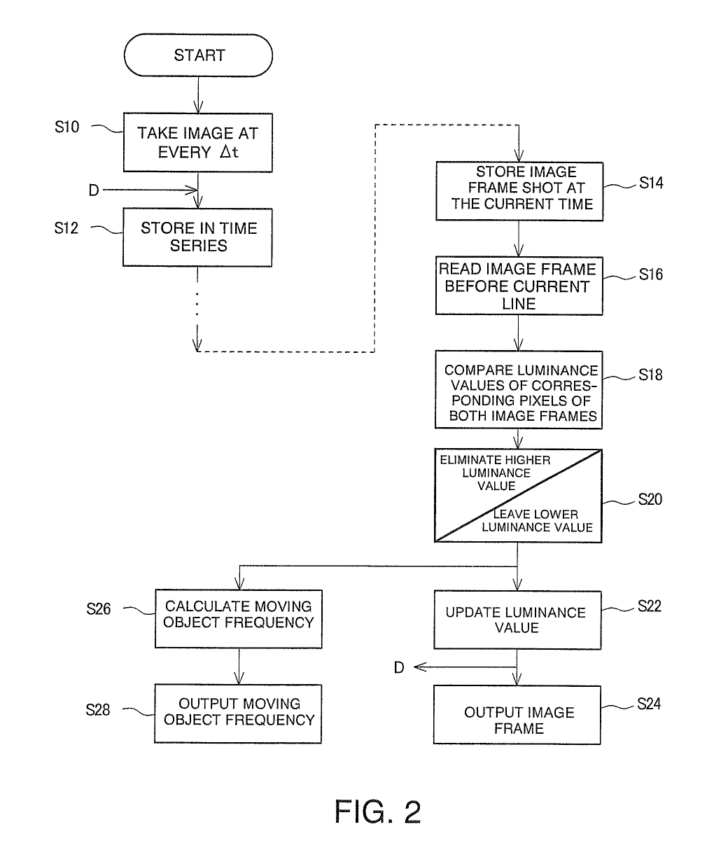

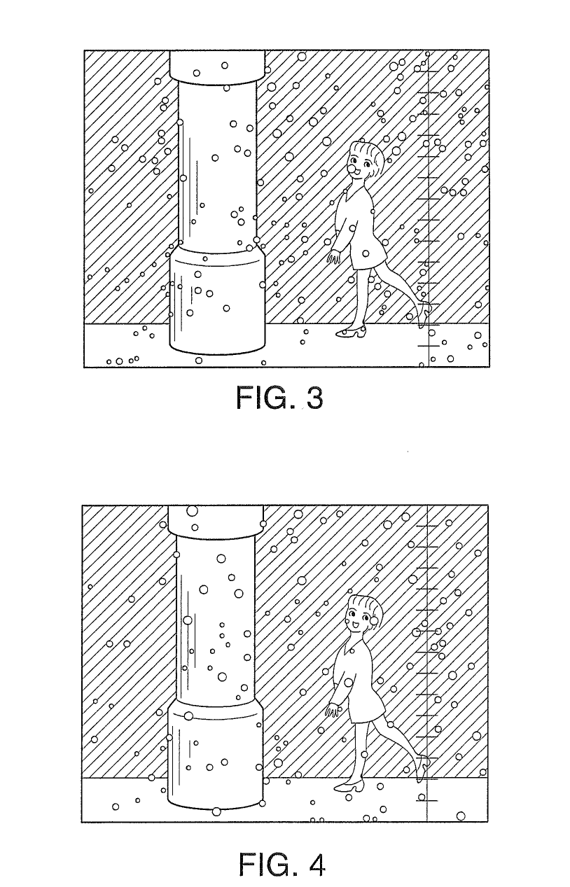

The operation of the moving object noise elimination processing device 10 having the above configuration will be described with the use of a flowchart of FIG. 2 and image frames shown in FIGS. 3 to 5. The following description will be given with the use of reference numerals of FIG. 1. The flowchart of FIG. 2 is a flowchart of procedures of the moving object noise elimination and the following procedures correspond to processing procedures of the moving object noise elimination processing program.

To monitor the outdoor situation 8, the camera 12 takes images at predetermined sampling intervals Δt (S10). This operation is implemented by the CPU 22 instructing the camera 12 to take images at Δt and transfer the shot data as image frame data, and by the camera 12 taking images in accordance with the instructions. The shot data is transferred through the signal line to the CPU 22 via the imaging device I/F 28.

The transferred image frame data is stored in the storage device 30 in correlation with a shooting time (S12). This operation is executed by the function of the storage/readout module 32 of the CPU 22.

S12 and S14 are repeatedly executed at each sampling time. Therefore, although the shot image frame data are sequentially stored in correlation with the shooting time in the storage device 30, actually, the image frames with noise eliminated are sequentially stored since the noise elimination is executed substantially in real time as described later.

The procedures other than S14 are related to the moving object noise elimination and the moving object frequency and are related to the process of the image data.

First, an image frame shot at the current time is stored (S14). This operation may be the same as S12 or the image frame may be stored in a temporary memory instead of S12. Of course, raw data shot by the camera 12 may be stored and an image frame shot in parallel with this data may be stored as data to be processed in a temporary storage memory in parallel with S12.

An image frame at a time before the current time is read from the storage device 30 (S16). The time before the current time may be a sampling time immediately before the sampling time of the current imaging or may be an earlier sampling time. The read image frame data is stored in a temporary memory different from the memory storing the image frame data at S14. The operations of S14 and S16 are executed by the function of the storage/readout module 32 of the CPU 22.

The data of the both image frames are compared in terms of luminance values of corresponding pixels (S18). This operation is executed by the function of the luminance value processing module 34 of the CPU 22. For example, if one image frame is made up of a matrix of 400 pixels in the horizontal direction defined as an X-direction and 500 pixels in the vertical direction defined as a Y-direction, a total of 400×500=200,000 pixels exist, and the corresponding pixels are pixels having the same X-direction position coordinate and Y-direction position coordinate in the two image frames. For example, if the luminance values of the pixels are prescribed with 256 gradations, the luminance values are numeric values from 0 to 255.

The two luminance values for the corresponding pixels in the two image frames are compared at S18, and a higher luminance value of the compared two luminance values is eliminated as a noise to leave a lower luminance value (S20). Since an object closer to the imaging device is generally imaged brighter, a moving object on the front side has a higher luminance value than an object to be imaged on the back side. Therefore, the higher luminance value is the luminance value of the moving object and the lower luminance value is the luminance value of the object to be imaged on the back side at the same pixel. The former may be eliminated as a noise and the latter may be left as the luminance value of the object to be imaged. This operation is executed by the function of the noise elimination module 36 of the CPU 22.

The luminance values of the pixels of the image frames are updated with the luminance values left at the pixels (S22). The image frames to be updated are preferably both the image frame stored at S14 and the image frame read at S16. Specifically, the luminance values of both image frames may be updated as follows. For example, the image frame read at S16 is used as a starting image frame to compare a luminance value K16 of one of the pixels of this image frame with a luminance value K14 of one corresponding pixel of the image frame stored at S14, and K14 is updated to K16 if K16 is lower than K14, and K16 is updated to K14 if K14 is lower than K16. In either case, the luminance values are updated to lower luminance values. This is sequentially performed for all the pixels to update the luminance values of the pixels of the two image frames to lower values in a unified manner.

By way of example, it is assumed that a certain pixel has K14=25 and K16=126. The luminance value of the image frame read at S16 is updated for this pixel, and the luminance values of the two image frames are unified to K14=K16=25. Assuming that another pixel has K14=180 and K16=27, the luminance value of the image frame stored at S14 is updated for this pixel, and the luminance values of the two image frames are unified to K14=K16=27. In the above example, the luminance values are updated for 200,000 respective pixels in this way.

Once the luminance values are updated for all the pixels making up the image frame, the image frame made up of the pixels having the updated luminance values is freshly stored in the storage device 30 as the image frame shot at the current time. In the flowchart of FIG. 2, the procedure goes back to S12 after S22 and the image frame is stored in time series. The stored time is a time defined as the “current time” at S14. As a result, the data stored as the image frame shot at the current time in a temporary storage device at S14 is updated and stored in the storage device 30.

The image frame made up of the pixels having the updated luminance values is output as an image frame of the object to be imaged (S24). This output image frame corresponds to the image frame shot at the current time and subjected to the noise elimination. This operation is executed by the function of the image output module 38 of the CPU 22.

FIGS. 3 and 4 depict how the operation works. FIG. 3 is a diagram of an appearance of an image frame shot Δt before the current time and corresponds to the image frame read at the operation of S16 of FIG. 2. In this image frame, a pillar of a building and a person is illuminated and brightly detected in front of a dark background. Although the background, the pillar of a building, and the person correspond to the objects to be imaged in the outdoor situation 8, the data of portions of the objects to be imaged is lacking due to falling snow in front of the objects to be imaged, i.e., closer to the camera 12 since it is snowing. Especially because the light is applied, falling snow in front of the objects to be imaged becomes brighter and has a higher luminance value, and the data of portions of the objects to be imaged is clearly lacking.

FIG. 4 is a diagram of an appearance of an image frame shot at the current time. The image frame is shot after Δt has elapsed from FIG. 3 and corresponds to the image frame stored at the operation of S14 of FIG. 2. Although the image frame of FIG. 3 and the image frame of FIG. 4 may be the same images if the person is in the substantially stationary state since the camera 12 is located at a fixed position, the portions relating to the falling snow are different in FIGS. 3 and 4 because falling snow is the moving object.

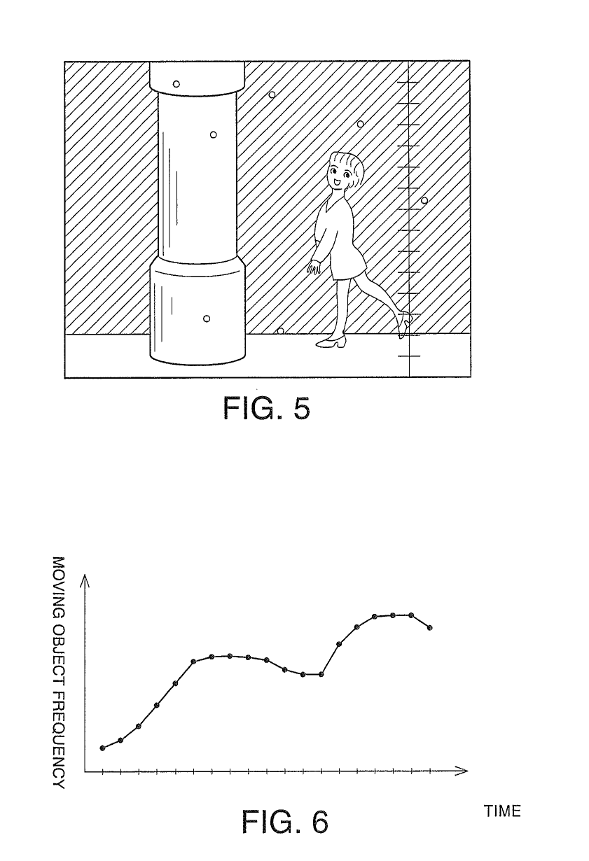

FIG. 5 depicts an image frame configured by comparing luminance values of corresponding pixels, eliminating the higher luminance values, leaving the lower values, and using a lower luminance value of the luminance values of each of the pixels in the image frame of FIG. 3 and the image frame of FIG. 4. As can be seen in FIG. 5, the noises of falling snow are substantially eliminated and the objects to be imaged, i.e., the dark background, the pillar of a building, and the person, are clearly detected.

Returning to FIG. 2, when Δt has further elapsed from the time defined as the current time at S14, the time is defined as the next current time, and the time defined as the current time at S14 is defined as a past time. At this timing, the image frame shot at the time newly defined as the current time is stored at S14. The data read out at S16 becomes the image frame data updated as above. For the two image frames, the operations of S18 and S22 are executed to update the image frame again based on a lower luminance value of the luminance values of each of the pixels, and the updated image frame is newly output as the image frame of the objects to be imaged at the current time. In this way, the image frame of the objects to be imaged is updated and output substantially in real time at each sampling time.

The moving object noises, i.e. falling snow noises, are gradually reduced by repeating the update as above. However, since the outdoor situation 8 is momentarily changed, if the luminance values are continuously updated always with lower luminance values, the changes in the luminance values of the objects due to the changes in the outdoor situation 8 become undetectable. Therefore, a predetermined update criterion is preferably provided for the update. It is desirable as the update criterion to constrain the number of times of update to the extent that the object noises such as falling snow noises are substantially eliminated and to start the process from S10 of FIG. 2 if the number is reached.

For example, about 2 to 10 image frames may be handled as a set subjected to the update process. By way of example, it is assumed that the current image frame is defined as i and that image frames are stored in time series of i−3, i−2, i−1, i, i+1, i+2, and i+3. The update process is sequentially executed for three image frames as a set. In this case, first, a result of the process executed by combining i−3 and i−2 is temporarily left in a memory as (i−2)^{P} and the process is then executed for (i−2)^{P} and i−1 to leave a result of the process as (i−1)^{P}, which is output as a result of the update through a set of three frames. Similarly, the update process is executed for a set of three frames of i−2, i−1, and i and the result is output as (i)^{P}. Of course, the process may be based on an update criterion other than that described above.

In experiments, falling snow noises may be eliminated by three to five updates even in the case of fairly heavy snowfall. Therefore, by setting the sampling interval to ⅕ to 1/10 of the sampling interval of the monitoring, the monitoring may be performed while effectively eliminating falling snow noises. For example, if the sampling interval of the monitoring is about 0.5 seconds, the sampling interval between taking images may be set to about 0.05 seconds to 0.1 seconds.

The calculation and output of falling snow frequency, i.e., the moving object frequency, will now be described. At S20 of FIG. 2, the data having a higher luminance value is eliminated as a noise at each of pixels of the two frames. Since the data having a higher luminance value is generated by falling snow, the number of pixels having the data having a higher luminance value is increased when the snowfall is heavier. Therefore, the heaviness of the snowfall is estimated from a rate of the number of luminance value data eliminated as noises to the total number of luminance value data of the pixels making up the image frame, and this is calculated as the moving object frequency (S26).

In the above example, the total number of pixels making up the image frame is 200,000. Assuming that the number N of pixels eliminated as those having higher luminance values at S20 is obtained to be N=500 at a certain time and N=1,000 at another time, it may be estimated that a snowfall amount per unit time is greater at the time when N=1,000. Therefore, in the above example, N/200,000 is defined as the moving object frequency and is output, for example, as information related to a snowfall amount per unit time in the case of snowfall (S28).

FIG. 6 depicts an example of transition of the moving object frequency with time as the horizontal axis and the moving object frequency as the vertical axis. If the moving object is falling snow, FIG. 6 may be utilized as information related to the temporal transition of the snowfall amount per unit time.

### Second Example

Although the moving object noise is eliminated through comparison of the luminance values of the corresponding pixels in two image frames in the above description, a distribution of luminance values of corresponding pixels may be obtained in a plurality of image frames to eliminate the moving object noise based on the obtained luminance value frequency distribution.

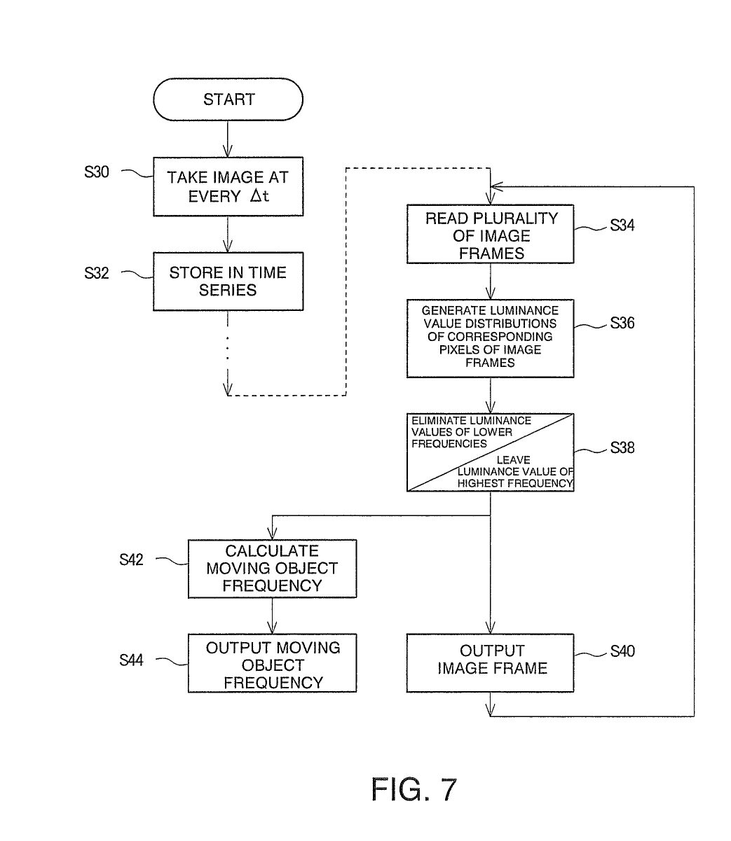

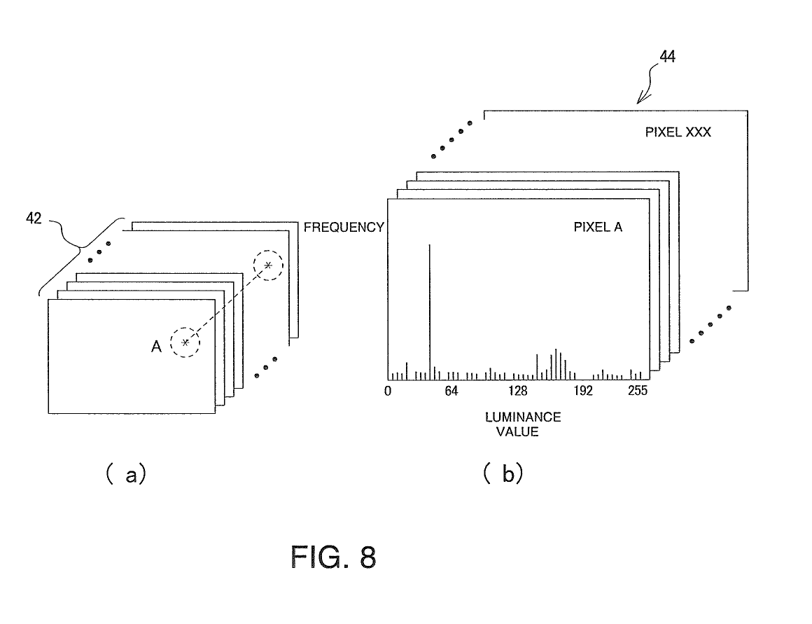

Although the details of the luminance value processing module 34 are different in the CPU 22 of the computer 20 of FIG. 1 in this case, other constituent elements are the same as the description in association with FIG. 1. Therefore, a method of eliminating the moving object noise based on the frequency distribution of luminance values of pixels will be described with reference to a flowchart of FIG. 7 and FIG. 8. This method is implemented by software executed by the computer 20 of FIG. 1.

FIG. 7 is a flowchart of procedures for eliminating the moving object noise based on the frequency distribution of luminance values of pixels and the following procedures correspond to processing procedures of the corresponding moving object noise elimination processing program.

To monitor the outdoor situation 8, the camera 12 takes images at predetermined sampling intervals Δt (S30). The shot data is transferred through the signal line to the CPU 22 via the imaging device I/F 28. The transferred image frame data is stored in the storage device 30 in correlation with the time of the shooting (S32). The details of operations at S30 and S32 are the same as the details of S10 and S12 described in FIG. 2 and therefore will not be described in detail.

S30 and S32 are repeatedly executed at each sampling time. Therefore, the shot image frame data are sequentially stored in correlation with the shooting time in the storage device 30.

The procedures from S34 are those related to the moving object noise elimination and the moving object frequency and are those related to the process of image data.

First, a plurality of image frames are read from the storage device 30 (S34). The plurality of image frames preferably include an image frame shot at the current time and are desirably a plurality of image frames tracking back to the past. By using a plurality of the latest image frames in this way, the credibility of the image data is improved and the real-time processing is enabled. The number n of the image frames may be in the order of n=50 to n=100, for example. Of course, n may be other than those numbers.

The luminance value distribution is obtained for each of corresponding pixels in a plurality of the read image frames (S36). The meaning of the corresponding pixels and the meaning of the luminance value is the same as those described in association with S18 of FIG. 2. Although the process of obtaining the luminance value distribution is executed by the function of the luminance value processing module 34 of the CPU 22 of FIG. 1, the process is different from the details of S18 and the details of S36 described in FIG. 2.

FIG. 8 depicts how the luminance value distribution is obtained for each of the corresponding pixels. FIG. 8(a) depicts a corresponding pixel indicated by A in each of a plurality of image frames 42. In the above example, the number n of image frames is 50 to 100. FIG. 8(b) depicts an appearance of a frequency distribution 44 of luminance values of each pixel for the n image frames. The luminance value frequency distribution is represented with the luminance value as the horizontal axis and the frequency count as the vertical axis. The luminance value is 0 to 255 in the above example. A total frequency count is n in the above example. The appearance of the luminance value distribution for the pixel A is depicted at the front; the frequency is highest at a luminance value of 40; a moderately high frequency distribution is seen around a luminance value of 150; and frequencies of other luminance values are substantially the same. Such a luminance value distribution is obtained for each pixel. In the above example, the luminance value distributions are obtained for 200,000 pixels.

Describing the frequency distribution of the pixel A of FIG. 8(b), it is thought that the noises such as falling snow have higher luminance values and have variations in the luminance distribution. On the other hand, the outdoor situation 8 to be monitored includes a dark background, a pillar of a building, and a person in the above example, and if these elements are in the substantially stationary state, these elements have substantially constant luminance values and smaller differences among image frames, and it is therefore thought that the luminance values are less scattered and have sharp peaked frequencies. The luminance values of the dark background, the pillar of a building, the person, etc., are luminance values lower than the moving object noises in the front thereof. Therefore, in the example of FIG. 8(a), it may be considered that the data at 40 having the highest frequency and a relatively low luminance value is generated by the dark background, the pillar of a building, and the person, which are included in the outdoor situation 8 to be monitored and that the data around 150 having variations, the second highest frequency, and relatively high luminance values is generated by falling snow noises.

As above, at S36, the luminance value distribution is obtained for each of the corresponding pixels in a plurality of image frames. The purpose thereof is to obtain the luminance value of the highest frequency for each pixel. Therefore, the number n of the image frames may be such a number that a significant difference is found between the highest frequency and the next highest frequency. For example, n may be set such that a ratio of the highest frequency to the next highest frequency is severalfold. In the above example, n=50 to 100 is used when it is snowing heavily, and the luminance value of the highest frequency may be sufficiently extracted if n indicates several frames in the case of the light snowfall. The number n of the image frames for obtaining the luminance value of the highest frequency may be selected depending on the level of snowfall. For example, the number n of the image frames may be selected from three levels such as n=10, 50, and 100.

Returning to FIG. 7, once the luminance value of the highest frequency is obtained for each of the pixels at S36, the luminance value of the highest frequency is left and other luminance value data are eliminated for each of the pixels (S38). This operation is executed by the function of the noise elimination module 36 of the CPU 22 of FIG. 1. In this case, it is preferable to update the luminance values for all the image frames used in the luminance value frequency distributions. For example, in the above example, if the number of image frames is n=50, each of the pixels are updated to the luminance value of the highest frequency in all the image frames.

By way of example, it is assumed that the luminance value of the highest frequency is K=40 and the frequency is 15/50 for the pixel A of FIG. 8. In this case, although the pixel A remains at K=40 in 15 image frames, the luminance of the pixel A is updated to K=40 in the remaining 35 image frames. This is performed for all the pixels to convert the 50 respective image frames into the image frames of the objects to be imaged with the moving object noises eliminated.

The image frames with the moving object noises eliminated are then output (S40). The moving object frequency is calculated based on the data of the eliminated luminance values (S42) and is output as the moving object frequency (S44).

The moving object frequency may be calculated as follows. In the above example, at the pixel A in the n=50 image frames, the number of the image frames having the highest frequency luminance value K=40 is n=15 and the detected luminance values are eliminated and updated to K=40 in the n=35 image frames. Therefore, at the pixel A, the total number of the luminance value data is 50 and the number of the data of the eliminated luminance values is 35. This calculation is performed for all the pixels to estimate the moving object frequency based on the total number of the luminance value data and the number of the data of the eliminated luminance values.

### Third Embodiment

The first and second examples are applicable when the object to be imaged is in the fixed state, in the substantially stationary state, or sufficiently greater than the moving objects (snow particles) in the outside situation 8. The substantially stationary state means that the movement speed of the object to be imaged in the screen is a sufficiently slower speed than the movement speed of the moving object in the screen, and the “slower speed” means that an object requires a longer time to pass by a certain pixel. In the case of falling snow, the falling speed does not fluctuate drastically and, for example, the outdoor snow falling speed is described as 400 mm/sec to 1000 mm/sec in Nonpatent Literature 1. Therefore, in an example when a ratio of outdoor speed is directly reflected on the screen, if the movement speed of the moving object is ½ to 1/10 of the snow falling speed out of doors, this speed may be defined as the substantially stationary state relative to the moving object in terms of the image processing.

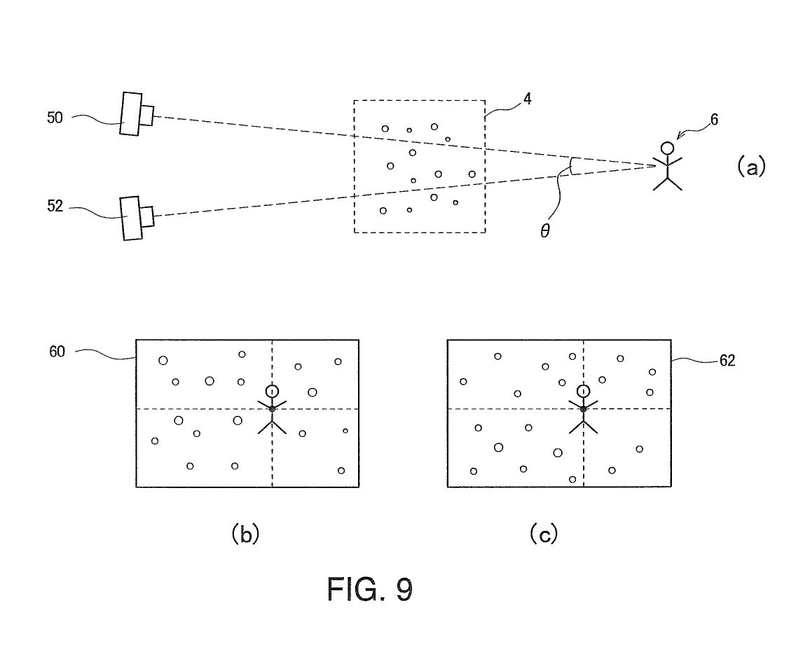

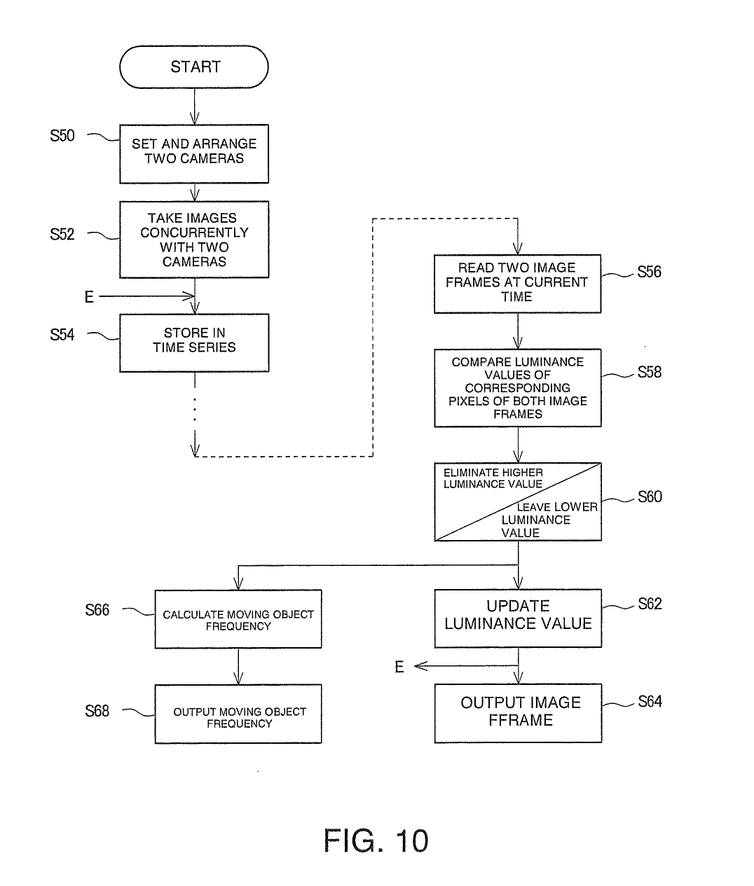

If the object to be imaged moves at a speed that is not negligible relative to the movement speed of the moving object, the method of the first and second examples generate errors in the noise elimination and the movement object frequency calculation. In such a case, two cameras may be used to take images of the outdoor situation at the same time to eliminate the moving object noise in front of the object to be imaged from the two image frames. A method of eliminating the moving object noise with the use of two cameras will hereinafter be described with reference to FIGS. 9 and 10. Reference numerals of FIGS. 1 to 8 are used in the following description.

FIG. 9 is a diagram explaining a principle of eliminating noise due to a moving object 4 in front of an object to be imaged 6 by taking images of the moving object to be imaged 6 at the same time with the use of two cameras 50, 52. FIG. 9(a) depicts a positional relationship of the two cameras 50, 52, the object to be imaged 6, and the moving object 4, and FIGS. 9(b) and 9(c) depict respective appearances of the image frames shot by the two cameras 50, 52. The two cameras 50, 52 may be the same two cameras 12 described in FIG. 1 and may be provided with lighting devices.

The arrangement of the two cameras 50, 52 is set under the following conditions. The cameras 50, 52 are arranged with a separation distance from each other such that the positions of the object to be imaged in the respective shot image frames are mismatched within arbitrarily defined pixels in the image frames when the object to be imaged 6 having the moving object 4 in front thereof is shot as the image frames. The separation distance generating a mismatch within arbitrarily defined pixels may be, for example, a separation distance generating a mismatch within one pixel for the object to be imaged 6 located in the vicinity of the center of the image frame. A mismatch within several pixels is allowed to be generated at positions other then the vicinity of the center of the image frame. Specifically, the light axis directions of the two cameras 50, 52 are tilted by a few degrees from zero degrees relative to each other. In FIG. 9(a), the tilt is indicated by an angle θ between the light axes of the two cameras 50, 52. The angle θ is varied depending on a distance between the two cameras 50, 52 and the object to be imaged, a focal distance of a lens, and the pixel resolution of the image frames. For example, if the distance between the two cameras 50, 52 and the object to be imaged 6 is sufficiently long, a smaller angle θ is available, and in some cases, the two light axes may be substantially parallel, i.e., the angle θ may be substantially zero degrees. If the pixel resolution of the image frames is high, a smaller angle may be used. By way of example, if an image frame is made up of several hundred thousand pixels and a distance to the object to be imaged 6 is 5 m or more, the angle θ may be about five degrees or less, preferably, about one to about two degrees.

By setting the arrangement relationship of the two cameras 50, 52 as above, when the two cameras 50, 52 takes images of the object to be imaged 6 at the same time, the object to be imaged 6 is located at the same positions and the moving object 4 in front thereof is located at different positions in the two image frames shot by the respective cameras 50, 52. This is depicted in FIGS. 9 (b) and 9 (c). FIG. 9 (b) depicts an image frame 60 shot by the camera 50 and FIG. 9(c) depicts an image frame 62 shot by the camera 52. In the image frames 60, 62, a person, i.e., the object to be imaged, is located at the same positions while falling snow, i.e., the moving object 4 is located at different positions. Since the two image frames 60, 62 are shot at the same time, the same falling snow is actually imaged and falling snow itself is not displaced between frames.

By taking images at the same time with the two cameras 50, 52 set in a predetermined arrangement relationship, the moving object to be imaged 6 may be shot at the same positions and the moving object 4 in front of the object to be imaged 6 may be shot at different positions in the two image frames. The moving object to be imaged 6 may remain stationary and the moving object 4 may be displaced in the two image frames shot at the same time. This shows the same relationship as two image frames formed by shooting the stationary object to be imaged 6 and the moving object 4 in time series. Therefore, the two image frames shot at the same time by the two cameras 50, 52 set in a predetermined arrangement relationship may be handled as the two image frames described in FIG. 2 to eliminate the moving object noise. This is the principle of eliminating the moving object noise for the moving object to be imaged with the use of two cameras.

FIG. 10 is a flowchart of procedures for eliminating the moving object noise with the use of two cameras. The following procedures correspond to processing procedures of the moving object noise elimination processing program. Reference numerals of FIGS. 1 to 9 are used in the following description.

First, the two cameras 50, 52 are set under the predetermined arrangement condition (S50). To monitor the outdoor situation 8, the cameras 50, 52 take images at the same time at predetermined sampling intervals Δt (S52). The shot data are differentiated as two image frame data and the respective data are transferred through the signal line to the CPU 22 via the imaging device I/F 28. The transferred image frame data are stored in the storage device 30 in correlation with the shooting time (S54). The operations of S52 and S54 are the same as the details of S10 and S12 described in FIG. 2 except the two cameras 50, 52 and two image frames and therefore will not be described in detail.

The procedures from S56 are those related to executing the moving object noise elimination based on the two image frames shot at the same time by the two cameras 50, 52 and calculating the moving object frequency and are those related to the process of image data.

First, two image frames shot at the current time are read out (S56). Since the object to be imaged 6 is located at the same positions and the moving object 4 is located at different positions as above, the two read image frames look as if the frames are in the same relationship as the two image frames at S14 and S16 of FIG. 2. Therefore, the subsequent operations may be processed in the same way as the details of the operations from S18 of FIG. 2.

The data of the both image frames are compared in terms of luminance values of corresponding pixels (S58). This operation is executed by the function of the luminance value processing module 34 of the CPU 22; the details thereof are the same as S18 described in FIG. 2; and the meaning of the corresponding pixels and the meaning of the luminance value is also the same as those described at S18.

A higher luminance value of the compared two luminance values is eliminated as a noise to leave a lower luminance value (S60). This operation is executed by the function of the noise elimination module 36 of the CPU 22 and the details are the same as S20 described in FIG. 2.

The luminance values of the pixels of the image frames are updated with the luminance values left at the pixels (S62). The method of the update is the same as the details described at S22 of FIG. 2. Once the luminance values are updated for all the pixels making up the image frame, the image frame made up of the pixels having the updated luminance values is freshly stored in the storage device 30 as the image frame shot at the current time, and the procedure goes back to S54 to store the image frame in time series. The image frame made up of the pixels having the updated luminance values is output as an image frame of the object to be imaged (S64). These processes are the same as those described at S22 and S24 of FIG. 2. The details of the moving object frequency calculation (S66) and the moving object frequency output (S68) are the same as those of S26 and S28 of FIG. 2.

As above, the moving object noise may be eliminated and the moving object frequency may be calculated by taking images of the outdoor situation to be monitored at the same time with two cameras set in a predetermined arrangement relationship and processing the two acquired image frames.

### INDUSTRIAL APPLICABILITY

The moving object noise elimination processing device 10, etc., is preferred for applications associated with a necessity to eliminate as a noise a moving object such as falling snow, falling rain, a pedestrian, and a passing vehicle present in front of an object to be monitored and, specifically, for various monitoring cameras disposed outdoors and an imaging device mounted on a vehicle.

1. A moving object noise elimination processing device comprising:
a fixed imaging device that shoots an object to be imaged with a moving object in front thereof as an image frame;
a memory that stores a shot image frame in correlation with time of the shooting; and
a processing means that processes the shot image frame; and
an output means that output an image frame processed based on a predetermined update criterion,
the processing means comprising:
a means that reads an image frame shot at a time before the current time from the memory,
a means that compares luminance values of corresponding pixels of two image frames between one read image frame and one image frame shot at the current time, and
a noise elimination complementing means that eliminates pixel data having higher luminance value as a noise for each of pixels of the two image frames compared in terms of the luminance values and that uses pixel data having a lower luminance value to complement the pixel having the pixel data eliminated.

2. A moving object noise elimination processing device comprising:
a fixed imaging device that shoots an object to be imaged with a moving object in front thereof as an image frame;
a memory that stores a plurality of the shot image frames in correlation with time series of the shooting; and
a processing means that processes the shot image frames; and
an output means that outputs an image frame processed based on a predetermined update criterion,
the processing means comprising:
a means that reads a plurality of image frames from the memory,
a means that generates a luminance value frequency distribution for each of corresponding pixels for a plurality of the read image frames,
a noise elimination complementing means that eliminates pixel data having luminance values other than the luminance value of the highest frequency in the luminance value frequency distribution for each of the pixels for which the luminance frequency distributions are generated and that uses pixel data having the luminance value of the highest frequency to complement the pixel having the pixel data eliminated.

3. A moving object noise elimination processing device comprising:
two fixed imaging devices that shoot an object to be imaged with a moving object in front thereof as image frames, the two fixed imaging devices being arranged with a separation distance from each other such that the positions of the object to be imaged in the respective shot image frames are mismatched within arbitrarily predefined pixels in the image frames;
a memory that stores the two respective image frames shot by the fixed imaging devices; and
a processing means that processes the shot image frames; and
an output means that outputs an image frame processed based on a predetermined update criterion,
the processing means comprising:
a means that reads two image frames shot at the same time by the fixed imaging devices from the memory,
a means that compares luminance values of corresponding pixels of two image frames between the two read image frames,
a noise elimination complementing means that eliminates pixel data having a higher luminance value as a noise for each of pixels of the two image frames compared in terms of the luminance values and that uses pixel data having a lower luminance value to complement the pixel having the pixel data eliminated.

4. The moving object noise elimination processing device of any one of claims 1 to 3, comprising:
a means that estimates a frequency of presence of the moving object in front of the object to be imaged based on the total number of data of luminance values of pixels making up an image frame and the number of data of luminance values eliminated as noises to output the frequency of presence as a moving object frequency.

5. The moving object noise elimination processing device of any one of claims 1 to 3, wherein:
the moving object is falling snow.

6. The moving object noise elimination processing device of any one of claims 1 to 3, comprising:
a lighting device that applies light from the fixed imaging device side toward the object to be imaged.

7. A program outputting an image frame processed based on a predetermined update criterion after executing a moving object noise elimination process by shooting an object to be imaged with a moving object in front thereof as an image frame with a fixed imaging device and by processing the shot image frame on a computer, the program operable to drive the computer to execute:
a processing step of reading an image frame shot at a time before the current time from a memory that stores an image frame shot by the fixed imaging device in correlation with time of the shooting;
a processing step of comparing luminance values of corresponding pixels of two image frames between one read image frame and one image frame shot at the current time; and
a noise elimination complementing step of eliminating pixel data having a higher luminance value as a noise for each of pixels of the two image frames compared in terms of the luminance values and using pixel data having a lower luminance value to complement the pixel having the pixel data eliminated.

8. A program of outputting an image frame processed based on a predetermined update criterion after executing a moving object noise elimination process by shooting an object to be imaged with a moving object in front thereof as an image frame with a fixed imaging device and by processing the shot image frame on a computer, the program operable to drive the computer to execute:
a processing step of reading a plurality of image frames from a memory that stores image frames shot by the fixed imaging device in correlation with time series of the shooting;
a processing step of generating a luminance value frequency distribution for each of corresponding pixels for a plurality of the read image frames; and
a noise elimination complementing step of eliminating pixel data having luminance values other than the luminance value of the highest frequency in the luminance value frequency distribution for each of the pixels for which the luminance frequency distributions are generated and using pixel data having the luminance value of the highest frequency to complement the pixel having the pixel data eliminated.

9. A program of outputting an image frame processed based on a predetermined update criterion after executing a moving object noise elimination process by shooting image frames with two fixed imaging devices that shoot an object to be imaged with a moving object in front thereof as image frames and that are arranged with a separation distance from each other such that the positions of the object to be imaged in the respective shot image frames are mismatched within arbitrarily predefined pixels in the image frames and by processing the shot image frames on a computer, the program operable to drive the computer to execute:
a processing step of reading two image frames shot at the same time by the fixed imaging devices from a memory that stores the two respective image frames shot by the fixed imaging devices;
a processing step of comparing luminance values of corresponding pixels of two image frames between the two read image frames; and
a noise elimination complementing step of eliminating pixel data having a higher luminance value as a noise for each of pixels of the two image frames compared in terms of the luminance values and using pixel data having a lower luminance value to complement the pixel having the pixel data eliminated.

10. The moving object noise elimination processing device of any one of claims 1 to 3, wherein:
the moving object is falling snow; and
the moving object noise elimination processing device further comprises:
a calculating means that calculates a frequency of presence of the falling snow in front of the object to be imaged based on a total number of data of luminance values of pixels making up an image frame and a number of data of luminance values eliminated as noises; and
a means that outputs temporal transition of a snowfall amount per unit time by plotting the frequency of presence of the falling snow in relation to a time axis.
